(19) United States
(12) Patent Application Publication
(10) Pub. No.: US 2015/0232729 A1
(43) Pub. Date: Aug. 20, 2015

(54) ANTIFOGGING COMPOSITIONS AND METHODS OF MAKING THE SAME

(71) Applicant: Georgia Southern Research and Service Foundation, Statesboro, GA (US)

(72) Inventors: Jie Zhao, Statesboro, GA (US); Anthony Meyer, Vienna, GA (US); Weihua Ming, Statesboro, GA (US)

(21) Appl. No.: 14/627,748

(22) Filed: Feb. 20, 2015

Related U.S. Application Data
(60) Provisional application No. 61/942,353, filed on Feb. 20, 2014.

(51) Int. Cl. C09K 3/18; C09D 139/06; C09D 133/14

(52) U.S. Cl. CPC C09K 3/18; C09D 133/14; C09D 139/06

(57) ABSTRACT

Provided herein are antifogging compositions that contain an acrylic copolymer and a crosslinked polymer network derived from an alkylene oxide di(meth)acrylate polymer. The copolymer and the crosslinked polymer network form an interpenetrating polymer network. Typically, the copolymer and the crosslinked polymer network form a semi-interpenetrating polymer network.

### BACKGROUND

It is known that many plastic and glass subjects is in contact with moist air under different conditions (e.g., higher or lower temperature), micrometer-scale water (fogging) or ice droplets (frost) may form during the first few seconds of contact. In recent years, needs for improving antifogging properties of a plastic and glass surface have been ever-increasing.

Many antifogging coatings have recently been developed to mitigate fogging problems for a variety of applications such as eyeglasses, goggles, lenses, mirrors, and displaying devices in analytical and medical instruments.¹⁻¹¹ Most of the antifogging coatings are hydrophilic or supehydrophilic coatings, primarily due to their ability to significantly reduce light scattering by only allowing water to condensate in a thin-film-like form. Superhydrophilic coatings with water contact angles smaller than 5° demonstrate good antifogging property, but generally require complicated procedures to fabricate surface texture,^{7,12-15} which is the prerequisite to obtain superhydrophilicity (except superhydrophilic TiO₂ coatings,^{5,6} which however require UV illumination). In addition, many coatings of this type may not resist frost formation.

It is therefore an object of the invention to provide compositions that possess antifogging characteristics.

It is also an object of the invention to provide an antifogging coating composition particularly applicable to a high-temperature high-humidity environment, and/or a low-temperature high-humidity environment.

It is a further object of the invention to provide an article comprising the antifogging composition, for example, mask, eye glasses, advertising box, displaying windows including freezer/fridge door, pick-up lens, and testing equipment.

### BRIEF DESCRIPTION OF THE FIGURES

FIG. 1A-1D contains photographs of different glass slides: (a) control glass, (b) Rf-modified glass, (c) Copolymer-70, and (d) Copolymer-60, first stored at −20° C. for 30 minutes and then exposed to ambient lab conditions for 5 seconds.

FIG. 2A-2B contains graphs showing light transmission at normal incident angle for various samples: (a) as-prepared samples and (b) 5 seconds under ambient condition after being stored at −20° C. for 30 minutes. The spikes in the spectra were due to the light bulb.

FIG. 3 is a graph showing light transmission at normal incident angle for Copolymer-70 with different amounts of EGDMA, 5 seconds under ambient condition after being stored at −20° C. for 30 minutes.

FIG. 4A-4B contains graphs showing (a) water contact angle evolution on various samples as a function of time. (b) diameter change of the water droplet on various samples over the 600-s period, as expressed as ΔD/D₀ where ΔD=D−D₀, and D₀ and D are the initial diameter (time zero) and the diameter at different times, respectively, of the wetted area by the water droplet.

FIG. 5 is a schematic illustration showing an antifogging mechanism in the copolymer coating.

FIG. 6A-6B are photos of a control glass slide (left) and a glass slide covered with a terpolymer-based coating on both sides (right) after exposure to boiling water steam. FIG. 6A is a photo of the glass slides after exposure for 30 s. FIG. 6B is a photo of the glass slides after exposure for 60 s. All samples were placed 10 cm above boiling water.

### DETAILED DESCRIPTION OF THE DISCLOSURE

### I. Definitions

As used in the specification and the appended claims, the singular forms “a,” “an” and “the” include plural referents unless the context clearly dictates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats, and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Throughout the description and claims of this specification the word “comprise” and other forms of the word, such as “comprising” and “comprises,” means including but not limited to, and is not intended to exclude, for example, other additives, components, integers, or steps.

The term “copolymer” as used herein generally means any polymer comprising the reaction product of two or more monomers wherein the polymer is derived from at least two monomeric species. For example, a copolymer may be derived from amino alkyl (meth)acrylate monomer and alkyl (meth)acrylate monomer.

The term “interpenetrating polymer network” or “IPN” refers to a spatial arrangement of two or more polymers, wherein the polymers are at least partially interlaced on a polymer scale, but not covalently bonded to each other. Interpenetrating polymer networks are occasionally used to improve the physical properties of the antifogging compositions. Different kinds of IPNs and the ways in which they may be made are available from a number of sources in the literature, such as, for example, in Advances in Interpenetrating Polymer Networks, Volume 4, by Frisch & Klempner, and in Interpenetrating Polymer Networks by Klempner, Sperling, & Utracki. In addition, many patents describe compositions and methods for synthesizing various types of IPNs containing various components.

The term “about” as used herein means greater or lesser than the value or range of values stated by 1/10 of the stated values, but is not intended to limit any value or range of values to only this broader definition. For instance, a molar ratio of amino alkyl (meth)acrylate to alkyl acrylate of about 70:30 means a molar ratio between 63:37 and 77:23. Each value or range of values preceded by the term “about” is also intended to encompass the embodiment of the stated absolute value or range of values.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound. As used herein, a “wt. %” or “weight percent” or “percent by weight” of a component, unless specifically stated to the contrary, refers to the ratio of the weight of the component to the total weight of the composition in which the component is included, expressed as a percentage.

“Alkyl”, as used herein, refers to saturated or unsaturated aliphatic groups, including straight-chain alkyl, branched-chain alkyl, cycloalkyl, alkyl substituted cycloalkyl, and cycloalkyl substituted alkyl. Unless otherwise indicated, a straight chain or branched chain alkyl has 30 or fewer carbon atoms in its backbone (e.g., C₁-C₃₀ for straight chain, C₃-C₃₀ for branched chain), more preferably 20 or fewer carbon atoms, more preferably 12 or fewer carbon atoms, and most preferably 8 or fewer carbon atoms. In some embodiments, the chain has 1-6 carbons. Likewise, preferred cycloalkyls have from 3-10 carbon atoms in their ring structure, and more preferably have 5, 6 or 7 carbons in the ring structure. The ranges provided above are inclusive of all values between the minimum value and the maximum value.

The term “alkyl” includes both “unsubstituted alkyls” and “substituted alkyls”, the latter of which refers to alkyl moieties having one or more substituents replacing a hydrogen on one or more carbons of the hydrocarbon backbone.

Unless the number of carbons is otherwise specified, “lower alkyl” as used herein means an alkyl group, as defined above, but having from one to ten carbons, more preferably from one to six carbon atoms in its backbone structure. Preferred alkyl groups are lower alkyls.

The alkyl groups may also contain one or more heteroatoms within the carbon backbone. Examples include oxygen, nitrogen, sulfur, and combinations thereof. In certain embodiments, the alkyl group contains between one and four heteroatoms.

### II. Compositions

In general, the antifogging compositions contain an acrylic copolymer and a crosslinked polymer network derived from an alkylene oxide di(meth)acrylate polymer. The copolymer and the crosslinked polymer network form an interpenetrating polymer network. Typically, the copolymer and the crosslinked polymer network form a semi-interpenetrating polymer network.

i. Copolymer

The acrylic copolymer is typically formed from hydrophilic monomers such as amino alkyl (meth)acrylate and a more hydrophobic monomer such as alkyl (meth)acrylate. The copolymer may be a binary copolymer. Examples of suitable amino alkyl (meth)acrylate monomers include, but are not limited to, 2-(dimethylamino) ethyl (meth)acrylate, 2-(diethylamino) ethyl (meth)acrylate, 2-aminoethyl(meth)acrylate, 2-N-morpholinoethyl(meth)acrylate, and combinations thereof.

Examples of suitable alkyl (meth)acrylate monomers include, but are not limited to, methyl (meth)acrylate, ethyl (meth)acrylate, propyl (meth)acrylate, butyl (meth)acrylate, pentyl (meth)acrylate, and combinations thereof. Other suitable (meth)acrylate monomer include esters of α,β-monoethylenically unsaturated monocarboxylic and dicarboxylic acids having 3 to 6 carbon atoms with alkanols having 1 to 20 carbon atoms (e.g., esters of acrylic acid, methacrylic acid, maleic acid, fumaric acid, or itaconic acid, with C1-C20, C1-C12, C1-C8, or C1-C4 alkanols). Exemplary (meth)acrylate monomers include, but are not limited to, methyl acrylate, methyl (meth)acrylate, ethyl acrylate, butyl acrylate, isobutyl (meth)acrylate, ethyl (meth)acrylate, glycidyl (meth)acrylate, vinyl acetate, acetoacetoxyethyl (meth)acrylate, acetoacetoxypropyl (meth)acrylate, hydroxyethyl (meth)acrylate, tetrahydrofurfuryl (meth)acrylate, cyclohexyl (meth)acrylate, 2-ethoxyethyl (meth)acrylate, 2-methoxy (meth)acrylate, 2 (2 ethoxyethoxy)ethyl (meth)acrylate, 2-phenoxyethyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl (meth)acrylate, and combinations thereof. In one embodiment, the acrylic copolymer is formed from 2-(dimethylamino) ethyl (meth)acrylate and methyl (meth)acrylate.

The molar ratio of the amino alkyl (meth)acrylate and alkyl (meth)acrylate monomers are varied to tailor the hydrophilic-hydrophobic balance of the copolymer, which would enable water to diffuse through the coating, but remains insoluble in water. Typically, the ratio of hydrophilic monomer units to hydrophobic monomer units in the copolymer ranges from about 4:1 to 1:1.5. Generally, the molar ratio of the amino alkyl (meth)acrylate and alkyl (meth)acrylate monomers in the copolymer can vary between about 2:3 to about 4:1, respectively. For example, the copolymer may comprise amino alkyl (meth)acrylate and alkyl (meth)acrylate monomers with molar ratios of 50:50, 60:40, 70:30, and 80:20, respectively. In one embodiment, the molar ratio of amino alkyl (meth)acrylate and alkyl (meth)acrylate monomers in the copolymer is about 70:30, respectively.

The copolymer may be a terpolymer. For example, the copolymer may contain a N-vinyl amide monomer in addition to the amino alkyl (meth)acrylate and/or the alkyl (meth)acrylate monomers. Both acyclic and cyclic constructs of N-vinyl amide monomer may be used. Cyclic N-vinyl amides, also known as N-vinyl lactams, may be used, either alone or in combination with acyclic N-vinyl amides. Generally, the cyclic N-vinyl amide contain from 4 to 13 total carbon atoms. Examples of cyclic vinyl amides include, but are not limited to, N-vinyl-2-pyrrolidone; N-vinyl piperidone; N-vinyl-2-caprolactam; N-vinyl-3-methyl pyrrolidone; N-vinyl-4-methyl pyrrolidone; N-vinyl-5-methyl pyrrolidone; N-vinyl-3-ethyl pyrrolidone; N-vinyl-3-butyl pyrrolidone; N-vinyl-3,3-dimethyl pyrrolidone; N-vinyl-4,5-dimethyl pyrrolidone; N-vinyl-5,5-dimethyl pyrrolidone; N-vinyl-3,3,5-trimethyl pyrrolidone; N-vinyl-5-methyl-5-ethyl pyrrolidone; N-vinyl-3,5-trimethyl-3-ethyl pyrrolidone; N-vinyl-6-methyl-2-piperidone; N-vinyl-6-ethyl-2-piperidone; N-vinyl-3,5-dimethyl-2-piperidone; N-vinyl-4,4-dimethyl-2-piperidone; N-vinyl-6-propyl-2-piperidone; N-vinyl-3-methyl-2-caprolactam; N-vinyl-4-methyl-2-caprolactam; N-vinyl-7-methyl-2-caprolactam; N-vinyl-3,5-dimethyl-2-caprolactam; N-vinyl-3,7-dimethyl-2-caprolactam; N-vinyl-4, 6-dimethyl-2-caprolactam, N-vinyl-3,5,7-trimethyl-2-caprolactam, N-vinyl-7-ethyl-2-caprolactam; N-vinyl-4-isopropyl-2-caprolactam; N-vinyl-5-isopropyl-2-caprolactam; N-vinyl-4-butyl-2-caprolactam; N-vinyl-5-butyl-2-caprolactam; N-vinyl-4-butyl-2-caprolactam; N-vinyl-5-tert-butyl-2-caprolactam; N-vinyl-2-methyl-4-isopropyl-2-caprolactam; N-vinyl-5-isopropyl-7-methyl-2-caprolactam; and blends thereof. Other examples of suitable N-vinyl amide monomers include, but are not limited to, N-vinyl-propiolactam, N-vinyl-valerolactam, N-vinyl-formamide, N-vinyl-acetamide, N-Methyl-N-vinylacetamide, and combinations thereof. In one embodiment, the copolymer is formed from 2-(dimethylamino) ethyl (meth)acrylate, methyl (meth)acrylate, and N-vinyl-2-pyrrolidone (NVP). Acrylamide and acrylamide derivatives are also suitable monomers that can be used in the copolymer.

The molar ratio of the amino alkyl (meth)acrylate, alkyl (meth)acrylate, and N-vinyl amide monomers in the terpolymer ranges from about 1:1:1 to about 2.5:1:1.5, respectively. For example, the terpolymer may comprise amino alkyl (meth)acrylate, alkyl (meth)acrylate, and N-vinyl amide monomers with molar ratios of about 30:30:40, 40:30:30, or 50:30:20, respectively. In one embodiment, the terpolymer contains 2-(dimethylamino) ethyl (meth)acrylate, methyl (meth)acrylate, and N-vinyl-2-pyrrolidone with a molar ratio of about 50:30:20, respectively.

The molecular weight of the copolymers is not limited. In one embodiment, the molecular weight is in the range of from about 10,000 g/mol to about 500,000 g/mol. Typically, the molecular weight is in the range of from about 10,000 g/mol to about 200,000 g/mol.

a. Types of Copolymers

The copolymer may be branched or linear. Typically, the copolymer is linear. The monomers in the copolymer can be random, or alternating depending on the amino alkyl (meth)acrylate, alkyl (meth)acrylate, and N-vinyl amide monomers used to produce the copolymer. There may be a gradient or a statistical ordering of the monomer units into the copolymer.

ii. Crosslinked Polymer Network

The alkylene oxide di(meth)acrylate crosslinked polymer network prevents the copolymer from being overswollen by water, thus ensuring coating stability. Examples of suitable alkylene oxide di(meth)acrylate monomers that may be used to form the crosslinked polymer network include, but are not limited to, ethylene glycol dimethacylate, diethylene glycol di(meth)acrylate, triethylene glycol di(meth)acrylate, tetraethylene glycol di(meth)acrylate, 1,4-butanediol di(meth)acrylate, 1,3-butanediol di(meth)acrylate, propylene glycol di(meth)acrylate, glycerol di(meth)acrylate, and combinations thereof. In one embodiment, the alkylene oxide di(meth)acrylate polymer is ethylene glycol dimethacylate.

The alkylene oxide di(meth)acrylate polymer is between about 0.1 and 2.0 wt % relative to the copolymer. Typically, the alkylene oxide di(meth)acrylate polymer is about 0.5 wt % relative to the copolymer.

iv. Interpenetrating Polymer Network

Typically, the composition contains an interpenetrating network (IPN) between the copolymer and the alkylene oxide crosslinked polymer network. A suitable interpenetrating polymer network can encompass any one or more of the different types of IPNs listed and described below:

Sequential interpenetrating polymer networks, in which monomers or prepolymers for synthesizing the copolymer or the crosslinked polymer network are polymerized in the presence of the copolymer or crosslinked polymer network. These networks may have been synthesized in the presence of monomers or prepolymers of the copolymer or crosslinked polymer network, which may have been interspersed with the copolymer or crosslinked polymer network after its formation or cross-linking;

Simultaneous interpenetrating polymer networks, in which monomers or prepolymers of two or more polymers or polymer networks are mixed together and polymerized and/or crosslinked simultaneously, such that the reactions of the two polymer networks do not substantially interfere with each other;

Grafted interpenetrating polymer networks, in which the two or more polymers or polymer networks are formed such that elements of the one polymer or polymer network are occasionally attached or covalently or ionically bonded to elements of an/the other polymer(s) or polymer network(s);

Semi-IPNs, in which one polymer is cross-linked to form a network while another polymer is not; the polymerization or crosslinking reactions of the one polymer may occur in the presence of one or more sets of other monomers, prepolymers, or polymers, or the composition may be formed by introducing the one or more sets of other monomers, prepolymers, or polymers to the one polymer or polymer network, for example, by simple mixing, by solublizing the mixture, e.g., in the presence of a removable solvent, or by swelling the other in the one;

Full, or “true,” interpenetrating polymer networks, in which two or more polymers or sets of prepolymers or monomers are crosslinked (and thus polymerized) to form two or more interpenetrating crosslinked networks made, for example, either simultaneously or sequentially, such that the reactions of the two polymer networks do not substantially interfere with each other;

Homo-IPNs, in which one set of prepolymers or polymers can be further polymerized, if necessary, and simultaneously or subsequently crosslinked with two or more different, independent crosslinking agents, which do not react with each other, in order to form two or more interpenetrating polymer networks;

Gradient interpenetrating polymer networks, in which either some aspect of the composition, frequently the functionality, the copolymer content, or the crosslink density of one or more other polymer networks gradually vary from location to location within some, or each, other interpenetrating polymer network(s), especially on a macroscopic level; and

Thermoplastic interpenetrating polymer networks, in which the crosslinks in at least one of the polymer systems involve physical crosslinks, e.g., such as very strong hydrogen-bonding or the presence of crystalline or glassy regions or phases within the network or system, instead of chemical or covalent bonds or crosslinks.

### III. Methods of Use

The antifogging compositions increase the scope of applications where antifogging of subject surface in contact with moist air under different conditions (e.g., higher or lower temperature), micrometer-scale water (fogging) or ice droplets (frost) would be desirable. Example of subjects which fogs following changes in environmental conditions include, but are not limited to, mask, eyeglasses, goggles, lenses, mirrors, advertising box, display windows, diagnostic test strip, pick-up lens, displaying devices in analytical and medical instruments.

Articles can be prepared by coating the antifogging coating composition onto at least a part of at least one surface of a substrate by utilizing a conventional coating method, such as, wire rod coating, roll coating, curtain coating, rotogravure coating, spray coating, dip coating, air knife coating, spin coating, slit coating, flow coating, or the like. Coating can take place in any standard coating machine known to the person skilled in the art.

In order to ensure uniform coating, it may be desirable to treat the substrate surface prior to coating by rinsing or cleaning the surface, or performing a plasma, corona discharge or flame treatment methods. For example, glass surfaces may be washed or rinsed prior to coating while polymer surfaces may be pretreated with plasma or corona discharge prior to coating.

The antifogging coating composition of the invention can be prepared by using conventional methods and the invention has no limitation on the preparation method thereof. For example, the antifogging coating composition of the invention can be prepared by co-dissolving the dimethacrylate monomer with the copolymer in a suitable solvent, for example toluene. A UV initiator, such as 2-hydroxy-4′-(2-hydroxyethoxy)-2-methyl propiophenone may then be added. The solution can then be coated on the clean substrate. The coating is then cured under UV irradiation for a period of time then dried in a vacuum oven overnight.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

### EXAMPLES

### Example 1

### Synthesis and Properties of Poly(MMA-co-DMAEMA)

The poly(MMA-co-DMAEMA) copolymers were synthesized by free radical solution polymerization. Methyl (meth)acrylate (MMA) and 2-(dimethylamino)ethyl (meth)acrylate (DMAEMA), with different DMAEMA contents (50, 60, 70, and 80 mol %), were first dissolved in ethanol (10 wt %) in a 250-mL flask, followed by the addition of AIBN (the initiator, 0.5 wt % with respect to the total monomer mass). The reaction solution was then purged by argon for 20 minutes, and the polymerization was carried out at 70° C. for 24 hours. After polymerization, the product was precipitated and washed in hexane to remove possible unreacted monomer. The resultant copolymer was dried at 50° C. for 48 hours in a vacuum oven. The molar content of the DMAEMA unit in the purified copolymers was determined by ¹H-NMR to be 50%, 58%, 67% and 76%, respectively, which agreed with the theoretical values (50, 60, 70, and 80 mol %) quite well. Typical properties of the copolymers are listed below.

Physical properties of poly(MMA-co-DMAEMA) copolymers

| | Mₙ | PDI | T_{g} (° C.) |
|---|---|---|---|
| Copolymer-80 | 20000 | 3.2 | 29 |
| Copolymer-70 | 21000 | 2.5 | 40 |
| Copolymer-60 | 29000 | 1.8 | 54 |
| Copolymer-50 | 33000 | 1.9 | 62 |

(Molecular weight determined by GPC, again PS standards; T_{g} by DSC)

### Example 2

### Preparation of Copolymer Coatings with PEGDMA Cross-Linked Network

Ethylene glycol di(meth)acrylate (EGDMA, at 0.1, 0.5, 1.0 and 2 wt % relative to the copolymer) was co-dissolved with a random copolymer described in Example 1 in toluene (10 wt %), followed by the addition of a UV initiator, 2-hydroxy-4′-(2-hydroxyethoxy)-2-methyl propiophenone (1 wt % relative to EGDMA). The final coatings were labeled as SIPN-B50, SIPN-B60, SIPN-B70, and SIPN-B80, respectively, depending on the molar content of the DMAEMA content.

### Example 3

### Treatment of Glass with the Copolymer Compositions

Control Glass

Glass slides (1.5 cm×1.5 cm) were cleaned ultrasonically for 5 minutes, and then placed in a freshly prepared solution of concentrated H₂SO₄ and 30 vol % H₂O₂ (7/3, v/v) at 80° C. for 1 hour to remove organic contaminants and generate free hydroxyl groups on the surface. The glass slides were then rinsed with ultrapure water and ethanol, and dried with airflow.

Rf-Modified Glass

To render glass slides hydrophobic, the cleaned slide was chemically modified with 1H,1H,2H,2H-perfluorodecyl trichlorosilane via the chemical vapor deposition at 100° C. for 20 minutes in sealed vials. At the end of reaction, the treated slides were rinsed with anhydrous toluene, sonicated for 5 minutes to remove residue, and then dried in an oven at 100° C. for 30 minutes. The hydrophobic glass slide was labeled as Rf-modified glass.

Results of Treatment

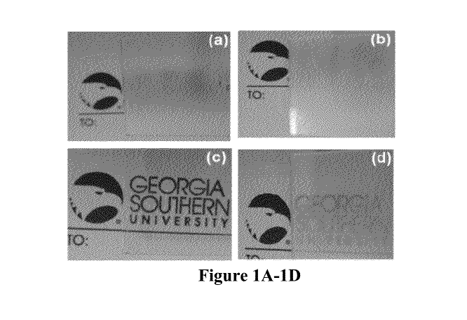

The SIPN-B50, SIPN-B60, SIPN-B70, and SIPN-B80 compositions (referred to in FIGS. 1-5 as Copolymer-50, Copolymer-60, Copolymer-70, and Copolymer-80, respectively) were spin-coated on clean glass slides (1.5 cm×1.5 cm) at 500 rpm for 15 seconds. The coating was cured under UV irradiation in a UVP CL-1000 Ultraviolet Crosslinker apparatus (365 nm, 15 w) for 45 minutes, and dried in a vacuum oven overnight. The final smooth coatings were approximately 450 nm in thickness and contained 0.5 wt % polymerized EGDMA unless otherwise stated.

Various samples of the coated glass slides were first stored in a freezer at −20° C. for 30 minutes, and photographs were taken after the sample was exposed to ambient conditions for 5 seconds. The control, a hydrophilic glass, fogged severely (FIG. 1a), so did a hydrophobically (perfluoroalkyl, Rf)-modified glass (FIG. 1b). Apparently, typical hydrophobic coatings are not suitable for antifogging applications [H. Lee, M. L. Alcaraz, M. F. Rubner and R. E. Cohen, ACS Nano, 2013, 7, 2172]. The observed fog was initially frost, which turned into fog as the sample temperature increased. In sharp contrast, there was neither frost nor fog formation at all (FIG. 1c) for SIPN-B70; excellent clarity was obviously maintained. The sample SIPN-B60 showed some improvement, but the antifogging performance was not as good as SIPN-B70. These results clearly suggested that the hydrophilic DMAEMA units played a crucial role in antifogging performance.

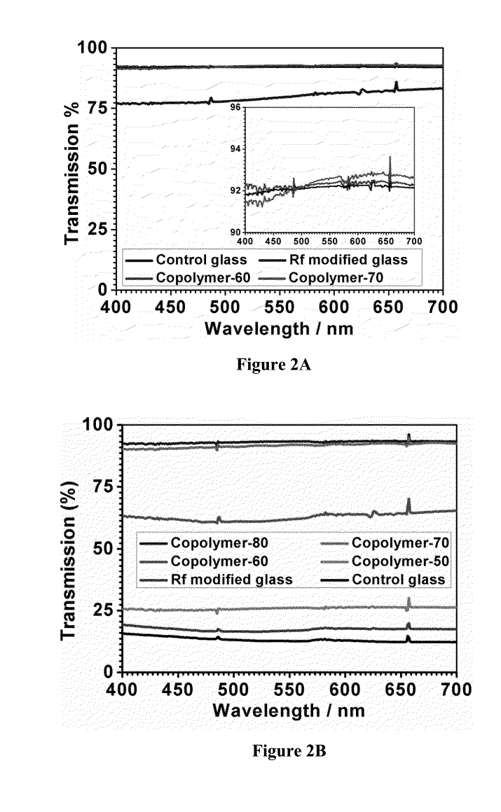

To evaluate the antifogging performance more quantitatively, light transmission over the 400-700 nm range was collected on an Agilent 8453 UV-vis spectrophotometer. Prior to fogging tests, SIPN-B70 and SIPN-B60 coatings on glass exhibited light transmission as high as the control glass (approximately 92%, FIG. 2a) over the wavelength range of 400-700 nm, indicating the random copolymer layer had negligible effect on glass transmittance. However, the transmission on the Rf-modified sample was significantly lower (approximately 77%).

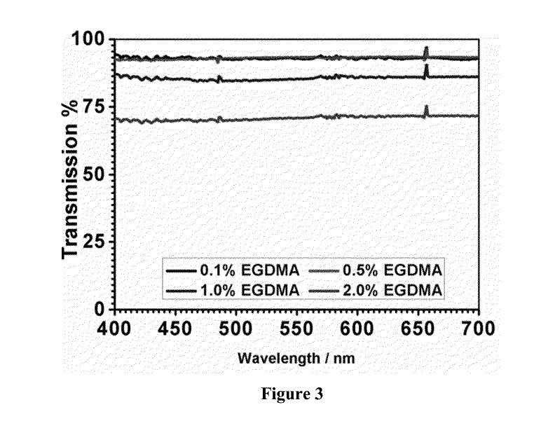

After being subjected to the same frosting/fogging test as above, the light transmission was again monitored. In the case of the control glass and Rf-modified glass, the light transmission decreased to below 20% (FIG. 2b), obviously due to severe fogging/frosting. On the copolymer coating surface, there appeared to be a strong dependence of transmission on the DMAEMA content (FIG. 2b). Both SIPN-B70 and SIPN-B80 maintained high transmission (>90%), on par with the values before the fogging test, which again confirmed that fog/frost formation on these surfaces was completely suppressed. In contrast, significant decrease in transmission was observed on SIPN-B60 and SIPN-B50, likely due to the lower DMAEMA content in these coatings. In the copolymer coatings, the DMAEMA content should be high enough to attract water molecules to diffuse into the polymer layer; however, it is likely that excessive DMAEMA units (in the case of SIPN-B80) would lead to over-swelling of the polymer by water (despite the PEGDMA network), thus reducing the stability of the coating upon contact with water. Therefore, there is a critical balance between water-swellability and coating stability, and SIPN-B70 with 70% DMAEMA in the copolymer (T_{g}: 40° C.), which was coupled with 0.5 wt % cross-linked PEGDMA (shown in FIG. 3), was the optimal coating with excellent antifogging/frost-resisting performance without compromising coating stability.

To optimize transmission and coating stability, the EGDMA content was varied (0.1-2 wt % against the copolymer content) in SIPN-B70 and the samples were subjected to a similar fogging test. The light transmission for the samples with high EGDMA contents (1 and 2 wt %) was significantly lower than their counterparts with lower EGDMA contents (FIG. 3). Higher EGDMA contents, after polymerization, led to a dense cross-linked network that would likely restrict the copolymer chain mobility when water molecules diffused into and swelled the copolymer, resulting in lower antifogging capability. With the lower contents of EGDMA (0.1 and 0.5 wt %), the cross-link network would likely be more diluted (compared to the samples with higher EGDMA contents), allowing the copolymer to swell to a greater extent by water and leading to better antifogging performance. However, when the EGDMA content was low (0.1 wt %), the coating appeared to be less stable, as indicated by blushing when the coating was submerged in water for 24 hours. Therefore, there is also an intricate interplay between coating swellability, cross-link network, and coating stability to achieve the best possible antifogging performance for the copolymer-based coatings. SIPN-B70 with 0.5 wt % of EGDMA appeared to have the optimum combination.

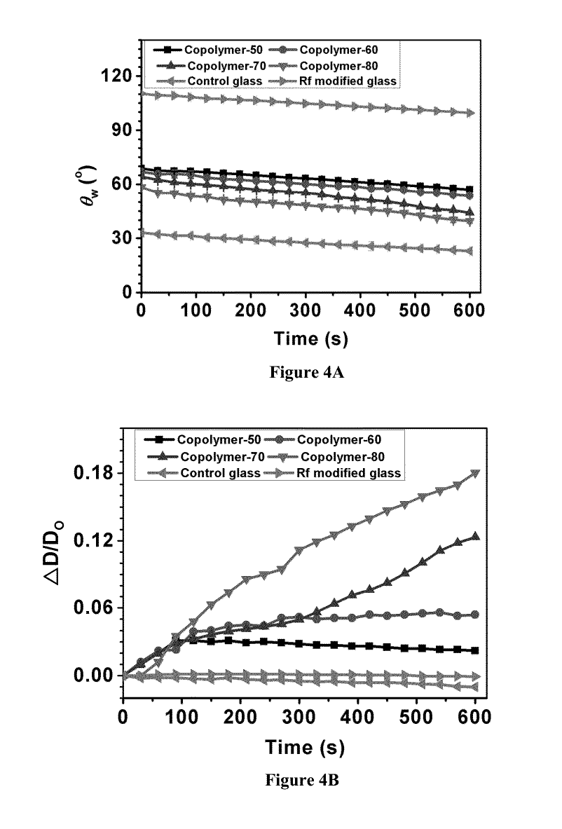

To reveal the origin of the antifogging/frost-resisting property of the copolymer coatings, the water contact angle (CA) change was monitored on these surfaces under ambient conditions. During the 600-s period, the water CAs all decreased (FIG. 4a), in part due to water evaporation; for instance, CA decreased by 10° on the control glass and Rf-Si-modified glass, about 13° for SIPN-B50 and SIPN-B60. On the other hand, more than 20° of CA decrease was observed on both SIPN-B70 and SIPN-B80 surfaces, suggesting that some water had gone somewhere else other than getting evaporated. The initial CAs for the copolymers were 60-70°, demonstrating that a coating does not have to superhydrophilic to be effectively antifogging.

The change in the diameter of the water contact area on the surface (FIG. 4b) was also simultaneously monitored. No change in the diameter was observed for Rf-Si-modified glass, and there was even slight decrease for the control glass. In contrast, the diameter increased on all four SIPN-B based surfaces: approximately 12% for SIPN-B70 and 18% for SIPN-B80, respectively, and smaller increase for other two coatings with lower DMAEMA contents over the 600-s period. This observation suggests that water had diffused into the copolymer coating, causing the expansion of the droplet contact area with the polymer surface, and the more DMAEMA segments in the coating, the more significant the water diffusion became. This remarkable water-absorbing capability, coupled with the coating stability due to the cross-linked PEGDMA network, contributed to the excellent antifogging/frost-resisting properties of SIPN-B70.

The SIPN-B70 coating was also exposed to boiling water steam. When the time of exposure was less than 5 seconds, no fogging occurred, but the surface did fog after longer periods of exposure. A possible cause for the poor antifogging behavior at high temperatures is the low critical solution temperature (LCST) of DMAEMA-based polymers. Pure PDMAEMA has a LCST of 38 to 40° C. in water [Burillo, E. Bucio, E. Arenas, G. P. Lopez, Macromol. Mater. Eng., 2007, 292, 214] so the copolymer with 70% DMAEMA was expected to have a slightly higher LCST. When the SIPN-B coating was exposed to boiling water steam, the temperature of the coating would increase to be above its LCST, making the copolymer no longer hydrophilic. As a consequence, water molecules could not diffuse into the polymer layer, leading to poor antifogging performance.

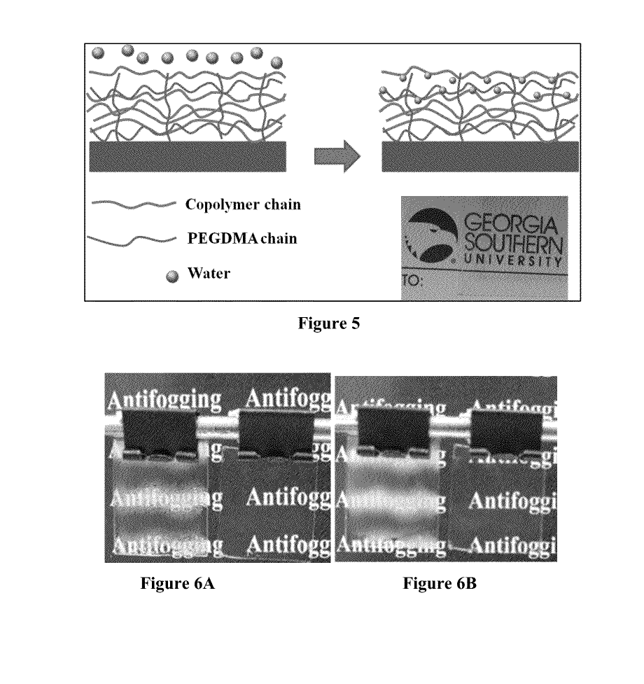

A possible antifogging mechanism for this new type of antifogging coatings is as follows. When molecular water in moist air from either a warmer or colder environment starts to condensate on the antifogging surface, the water molecules are immediately and rapidly absorbed into the hydrophilic segments of the copolymer (FIG. 5), not allowing (micro)droplets to form on the coating surface (fogging or frosting). Once inside the copolymer coating, water molecules may exist in the nonfreezing state [H. Lee, M. L. Alcaraz, M. F. Rubner and R. E. Cohen, ACS Nano, 2013, 7, 2172] due to the strong polymer-water hydrogen-bonding [H. Ohno, M. Shibayama, and E. Tsuchida, Makromol. Chem., 1983, 184, 1017; M. S. Sanchez, G. G. Ferrer, M. M. Pradas and J. L. G Ribelles, Macromolecules, 2003, 36, 860] avoiding formation of large light-scattering water domain.

### Example 4

### Synthesis of Terpolymers poly(DMAEMA-co-NVP-co-MMA)

Poly(DMAEMA-co-NVP-co-MMA) terpolymers were synthesized by free radical polymerization, similar to that of poly(MMA-co-DMAEMA) copolymers. A typical example is given as follows. Three monomers, DMAEMA, NVP (N-vinyl-2-pyrrolidone), and MMA with the molar percentage of 30% DMAEMA, 40% NVP, and 30% MMA were first dissolved in DMF (10 wt %) in a 250-mL flask, followed by the addition of AIBN as the initiator (0.5 wt % with respect to the total monomer mass). The reaction solution was then purged by argon for 20 minutes, and the polymerization was carried out at 70° C. for 24 hours. After polymerization, the product was precipitated and washed in cyclohexane to remove possible unreacted monomer. The resultant copolymer was dried at 50° C. for 48 hours in a vacuum oven. The final terpolymer was labeled Ter-30. Similarly, two other terpolymers were obtained with the following molar ratio: Ter-40 (40% DMAEMA, 30% NVP, and 30% MMA), and Ter-50 (50% DMAEMA, 20% NVP, and 30% MMA). The contents of the three monomer units in the terpolymers were confirmed by ¹H-NMR.

### Example 5

### Preparation of Terpolymer Coatings with PEGDMA Cross-Linked Network

Ethylene glycol di(meth)acrylate (EGDMA, at 0.5 wt % relative to the terpolymer) was co-dissolved with a terpolymer in toluene (10 wt %), followed by the addition of a UV initiator, 2-hydroxy-4′-(2-hydroxyethoxy)-2-methyl propiophenone (1 wt % relative to EGDMA). The solution was then spin-coated on clean glass slides (1.5 cm×1.5 cm) at 800 rpm for 15 seconds. The coating was cured under UV irradiation in a UVP CL-1000 Ultraviolet Crosslinker apparatus (365 nm, 15 w) for 90 minutes, and dried in a vacuum oven overnight. The final coatings on the basis of Ter-30, Ter-40, and Ter-50 were labeled as SIPN-T30, SIPN-T40, and SIPN-T50, respectively, depending on the molar content of the DMAEMA unit. The coating SIPN-T40 demonstrated the best antifogging (against both cold moist air and hot water vapor) and frost-resisting performance.

Upon much longer-time exposure (60 s) to boiling water steam, no fogging was observed for the sample covered with the terpolymer-based coating 6), and excellent optical clarity was maintained. In the meantime, the terpolymer-based coating also maintained excellent frost-resisting property.

### REFERENCES

1 L. Zhang, Y. Li, J. Sun and J. Shen, Langmuir, 2008, 24, 10851.
2 L. Zhang, Z. Qiao, M. Zheng, Q. Huo and J. Sun, J. Mater. Chem., 2010, 20, 6125.
3 J. R. Premkumara and S. B. Khoo, Chem. Commun., 2005, 5, 640.
4 N. Nuraje, R. Asmatulu, R. E. Cohen and M. F. Rubner, Langmuir, 2011, 27, 782.
5 R. Wang, K. Hashimoto, A. Fujishima, M. Chikuni, E. Kojima, and A. Kitamura, Nature 1997, 388, 431.
6 R. Wang, K. Hashimoto, A. Fujishima, M. Chikuni and E. Kojima, A. Kitamura, M. Shimohigoshi and T. Watanabe, Adv. Mater. 1998, 10, 135
7 (a) F. C. Cebeci, Z. Z. Wu, L. Zhai, R. E. Cohen and M. F. Rubner, Langmuir 2006, 22, 2856. (b) N. Nuraje, R. A. Asmatulu, R. E. Cohen and M. F. Rubner, Langmuir 2011, 27, 782.
8 P. Chevallier, S. Turgeon, C. Sarra-Bournet, R. Turcotte and G. Laroche, ACS Appl. Mater. Interfaces, 2011, 3, 750.
9 X. Liu, X. Du and J. He, Chem Phys Chem, 2008, 9, 305.
10 J. A. Howarter, K. L. Genson and J. P. Youngblood, ACS Appl. Mater. Interfaces, 2011, 3, 2022.
11 L. Xu and J. He, ACS Appl. Mater. Interfaces, 2012, 4, 3293
12 J. Xiong, S. N. Das, J. P. Kar, J.-H. Choi, J.-M. Myoung, J. Mater. Chem. 2010, 20, 10246.
13 N. J. Shirtcliffe, G. McHale, M. I. Newton, C. C. Perry and P. Roach, Chem. Commun., 2005, 3135
14 D. Tahk, T. Kim, H. Yoon, M. Choi, K. Shin, K. Y. Suh, Langmuir, 2010, 26, 2240.
15 X. Li and J. He, ACS Appl. Mater. Interfaces, 2012, 4, 2204.

We claim:

1. A composition comprising
(a) a copolymer derived from an alkyl acrylate monomer and an amino alkyl (meth)acrylate monomer, and
(b) a crosslinked polymer network derived from an alkylene oxide di(meth) acrylate monomer,
wherein the copolymer and the crosslinked polymer network form an interpenetrating polymer network.

2. The composition of claim 1, wherein the alkyl acrylate monomer is selected from the group consisting of methyl (meth)acrylate, ethyl (meth)acrylate, propyl (meth)acrylate, butyl (meth)acrylate, pentyl (meth)acrylate, and combinations thereof.

3. The composition of claim 1, wherein the amino alkyl (meth)acrylate monomer is selected from the group consisting of 2-(dimethylamino) ethyl (meth)acrylate, 2-(diethylamino) ethyl (meth)acrylate, 2-aminoethyl (meth)acrylate, 2-n-morpholinoethyl (meth)acrylate, and combinations thereof.

4. The composition of claim 1, wherein the copolymer is derived from methyl (meth)acrylate and 2-(dimethylamino) ethyl (meth)acrylate monomers.

5. The composition of claim 1, wherein the molar ratio of alkyl acrylate and amino alkyl (meth)acrylate units in the copolymer is between about 3:2 to 1:4.

6. The composition of claim 5, wherein the molar ratio of alkyl acrylate and amino ethyl (meth)acrylate units in the copolymer is about 1:2.3.

7. The composition of claim 1, wherein the alkylene oxide di(meth)acrylate monomer is selected from the group consisting of ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,3-butanediol di(meth)acrylate, propylene glycol di(meth)acrylate, glycerol di(meth)acrylate, and combinations thereof.

8. The composition of claim 7, wherein the alkylene oxide di(meth)acrylate monomer is ethylene glycol di(meth)acrylate.

9. The composition of claim 1, wherein the alkylene oxide di(meth)acrylate is between about 0.1 and 2.0 wt % relative to the copolymer.

10. The composition of claim 9, wherein the alkylene oxide di(meth)acrylate polymer is about 0.5 wt % relative to the copolymer.

11. The composition of claim 1, wherein the copolymer is a terpolymer.

12. The composition of claim 11, wherein the terpolymer is further derived from a monomer selected from the group consisting of N-vinyl amide, acrylamide, and acrylamide derivatives.

13. The composition of claim 12, wherein the N-vinyl amide monomer is selected from the group consisting of N-vinyl-2-pyrrolidone, N-vinyl-propiolactam, N-vinyl-valerolactam, N-vinyl-caprolactam, N-vinyl-formamide, N-vinyl-acetamide, N-Methyl-N-vinylacetamide, and combinations thereof.

14. The composition of claim 13, wherein the N-vinyl amide monomer is N-vinyl-2-pyrrolidone (NVP).

15. The composition of claim 12, wherein a molar ratio of amino alkyl (meth)acrylate, alkyl (meth)acrylate, and N-vinyl amide monomers in the copolymer is between about 1:3:6 to about 6:3:1, respectively.

16. The composition of claim 15, wherein a molar ratio of amino alkyl (meth)acrylate, alkyl (meth)acrylate, and N-vinyl amide monomers in the copolymer is about 1.3:1:1.

17. The composition of claim 15, wherein a molar ratio of amino alkyl (meth)acrylate, alkyl (meth)acrylate, and N-vinyl amide monomers in the copolymer is about 1:1:1.3.

18. The composition of claim 15, wherein a molar ratio of amino alkyl (meth)acrylate, alkyl (meth)acrylate, and N-vinyl amide monomers in the copolymer is about 2.5:1.5:1.

19. The composition of claim 1, wherein the copolymer is a linear or branched copolymer.

20. The composition of claim 1, wherein the copolymer and the crosslinked polymer network form a semi-interpenetrating polymer network.

21. A composition comprising
(a) a copolymer derived from an alkyl acrylate monomer and an amino alkyl (meth)acrylate monomer, and
(b) a crosslinked polymer network derived from an alkylene oxide tri(meth) acrylate monomer,
wherein the copolymer and the crosslinked polymer network form an interpenetrating polymer network.

22. An article, comprising:
a substrate and
a coating comprising a composition from claim 1.
